(19) United States
(12) Patent Application Publication
(10) Pub. No.: US 2021/0358066 A1
(43) Pub. Date: Nov. 18, 2021

(54) Intelligent Traffic Violation Detection System

(71) Applicants: Ahmad Abusaad, Jeddah (SA); Ahmad Basamh, Jeddah (SA)

(72) Inventors: Ahmad Abusaad, Jeddah (SA); Ahmad Basamh, Jeddah (SA)

(21) Appl. No.: 17/321,452

(22) Filed: May 16, 2021

Related U.S. Application Data
(60) Provisional application No. 63/026,051, filed on May 17, 2020.

(51) Int. Cl. G06Q 50/26; G06K 9/00

(52) U.S. Cl. CPC G06Q 50/26; G06K 9/325; G06K 9/00791

(57) ABSTRACT

The present invention relates to an intelligent traffic violation detection system for traffic violation detection and enforcement. Specifically, the present invention provides a system that identifies traffic violators, locate wanted vehicles, provide critical counter-terrorism services, auto related theft services, and other valuable analytics and services to be provided to the department of public security sector which will help improve traffic systems, traffic flow and national security in a novel unique way. The present invention provides a novel complete solution that comprises of a Portable Detection Device (PDD), Violation Detection Captain (VDC), Transfer of Information Agent (TOIA), Falcon Command & Control center (FCCc), Violation Verification System (VVS) and Verification Check Point (VCP).

### CROSS-REFERENCE TO RELATED APPLICATIONS

For purposes of the USPTO extra-statutory requirements, the present application constitutes a nonprovisional patent application of U.S. provisional patent application Ser. No. 63/026,051, entitled AN INTELLIGENT TRAFFIC VIOLATION DETECTION SYSTEM, naming AHMAD ABUSAAD and AHMAD BASAMH as inventors, filed May 17, 2020.

### FIELD OF THE INVENTION

The present invention relates to an intelligent traffic violation detection system for traffic violation detection and enforcement. Specifically, the present invention provides a system that identifies traffic violators, locate wanted vehicles, provide critical counter-terrorism services, auto related theft services, and other valuable analytics and services to be provided to the department of public security sector which will help improve traffic systems, traffic flow and national security.

### BACKGROUND OF THE INVENTION

Traffic violation enforcement typically has been and is an increasingly costly, inefficient, labour-intensive, labour-limited, and in some instances ineffective. Limited police resources are assigned across numerous competing duties and priorities, leaving relatively few police personnel for traffic enforcement where violators greatly outnumber the sparsely distributed enforcers. Over the years, different devices and systems have been introduced to improve the detection, documentation, and prosecution of traffic violations. However, most of the devices and traffic violation detection systems has their own drawbacks such as lack of robustness and data verification and authenticity.

Presently, capturing visual data such as images and videos manually at a particular location is the most common way to identify and capture offenses of traffic regulation. Most common practice is to install cameras at specific locations such as traffic signals and highways for monitoring the traffic violations. However, this traditional system provides poor efficiency as it can only monitor few vehicles that have passed through specific locations. Similarly, assigning few police personnel in specific locations to monitor and identify the traffic violations is not efficient in the current state with the increase in number of vehicles on roads. At this stage, it is understood that manpower alone using the traditional methods of identifying traffic violations is less productive. Similarly, autonomous systems alone may not be able to efficiently identify the traffic violations. In this scenario, there is a need of a more advanced, robust and efficient system that can intelligently integrate the manpower with the machine to identify most of traffic violations with utmost precision and authentication.

These and many other problems have been long identified. Different solutions to the problems have been tried. However there exists no comprehensive solution to all the above problems.

Therefore, the objective of the present invention overcomes the limitations and drawbacks from the prior art. To achieve above and other objectives, the present invention anticipates a new and entirely different system that resolves the limitations and drawbacks.

In view of the foregoing and other relevant problems, there is a need for a system that can identify the traffic violations more efficiently. Therefore, the object of the present invention is an intelligent traffic violation detection system that comprises of a Portable Detection Device (PDD), Transfer of Information Agent (TOIA) and Violation Verification System (VVS).

### SUMMARY OF THE INVENTION

In a preferred embodiment, the disclosed intelligent traffic violation detection system operates by installing the PDD into any vehicle that can be non-distractably operated by a Violation Detection Captain (VDC). The VDC can further manually captures the identified traffic violation by non-distractably operating the PDD through the remote trigger button located on the steering wheel of the vehicle. The PDD further captures the traffic violation and sends the data to The Eye Department via TOIA for further verification. The trigger action that enables real time capturing and recoding of the traffic violation can be further configured as automatic or manual.

In another preferred embodiment, the TOIA is stored in the PDD. Permission Tokens (P-Tokens can be added or removed by 5 different departments as follows: VDC & PDD can only add 1 P-Token each. Iris Employees from the Eye department has the ability to add or remove 1 P-Token where the Jury Team Department (JTD) & Operation Accuracy Officer (OAO), both have the ability to add or remove 2 P-Tokens at a time. TOIA is enabled when at least two P-Tokens are assigned, in which one P-Token is assigned by the VDC when they press the remote trigger button while the second P-Token is assigned automatically by the PDD device when it identifies the 10 required clues and operation is filed correctly with no errors. In the next step, the TOIA with the two assigned P-Tokens is further encrypted and transferred to the specified data centres where the traffic violation data stored in the TOIA is decrypted and further reviewed. The reviewed information is again loaded back to TOIA and further transferred to the “Eye department”. The Eye department comprises of two iris employees who reviews the traffic violation data embedded in the TOIA and approves or rejects the traffic violation claims. In a scenario where both iris employee's approval of the traffic violation data adds two additional P-Tokens to the TOIA leading to a total of four P-Tokens to the TOIA. Once a TOIA is assigned with four P-Tokens, it can be further transferred to Verification Check Point (VCP) where the VCP will ensure that TOIA has all four P-Tokens and grants the TOIA with a Golden Eye Stamp (GES). Once a TOIA is granted with a GES, it can be safely transferred to Electronic Ticket Issuance Gate (ETI-Gate) to issue an official electronic ticket that will further be sent to the appropriate government entity.

In accordance with another preferred embodiment, one iris employee's approval of the traffic violation data adds one additional P-Token to the specific TOIA leading to a total of three P-Tokens to the specific TOIA. At the same time, if the other iris employee rejects the provided traffic violation data, the additional third P-Token added will be removed from the specific TOIA leading to a total of two P-Tokens. In this scenario, specific TOIA with two P-Tokens will be further transferred to JTD. The JTD comprises of three members who reviews the TOIA with two P-Tokens and takes a decision to approve or reject the TOIA. If the JTD approves the provided traffic violation data, they grant two additional P-Tokens to the specific TOIA which leads to a total of four P-Tokens for specific TOIA. Once a TOIA is assigned with four P-Tokens, it can be further transferred to VCP where the VCP will ensure that TOIA has all four P-Tokens and grants the TOIA with a GES. Once a TOIA is granted with a GES, it can be safely transferred to ETI-Gate to issue an official electronic ticket that will further be sent to the appropriate government entity. However, if the JTD rejects the provided traffic violation data, the two P-Tokens provided to the TOIA will be removed leading to a zero P-Tokens. TOIA with the zero P-Tokens are further transferred to Operation Accuracy Department (OAD).

In another preferred embodiment, all the TOIA's with zero P-Tokens are redirected to OAD. The OAD comprises of an OAO who will review the provided traffic violation data and re-evaluate the case and approves or rejects the provided traffic violation data claims. In a scenario where the OAO approves the traffic violation data claims, the OAO grants two 2 P-Tokens to the specific TOIA and redirects the case to JTD for further re-evaluation. However, if the OAO rejects the provided traffic violation data claims, the claims will be disposed in the trash. Furthermore, if JTD approves the TOIA sent by OAD, the OAO will receive a detailed report on who denied the claim from the Eye department and will issue a mandatory training to those two employees, so they improve their skills thus improving overall quality. Similarly, if OAO denies the violation claim, a mandatory training shall be issued to the VDC who sent the wrong violation in the first instance and a short investigation might open on rare occasions. Correspondingly, when the JTD has sent TOIA and it was approved, OAO will receive notification upon which one of the two iris employees has evaluated that violation claim wrong. However, of JTD denies the violation claim, OAO will be notified which one of the two iris employees has approved the violation claim.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 provides a stepwise illustration of intelligent traffic violation detection system with a focused visualisation of the initial steps showing the VDC and the Virtual detection system.

FIG. 2 provides a stepwise illustration of intelligent traffic violation detection system with a focused visualisation of the steps involved in analysing the traffic violation data at Eye department.

FIG. 3 provides a stepwise illustration of intelligent traffic violation detection system with a focused visualisation of the steps involved to process through VCP.

FIG. 4 provides a stepwise illustration of intelligent traffic violation detection system with a focused visualisation of the steps involved to process through JTD.

FIG. 5 provides a stepwise illustration of intelligent traffic violation detection system with a focused visualisation of the steps involved to process through OAD.

### DETAILED DESCRIPTION OF PREFERRED EMBODIMENT(S)

The following detailed description is intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

In one embodiment of the present invention, the PDD is a device that has capability to capture audio visual data and transfer the captured data to the data centres. The PDD is one of the crucial elements of the intelligent traffic violation detection system where in, the said PDD comprises of a portable case, at least one video camera module that is mounted in a way to be capable of capturing at least 360-degree view around the vehicle, at least one image capturing camera module that is mounted in a way to be capable of capturing at least 360-degree view, at least one camera mount, at least one remote trigger, at least one microphone, at least one power source and a mobile application. In a preferred embodiment, the PDD can be operated automatically and manually wherein the automatic operation includes no trigger action and can be configured to loop-record five minutes, takes at least one image every three seconds, CPU will process the Licence Plate Recognition data (LPR) and automatically sends .txt files of all plate numbers, date, time and location to the data centres for data collection that can be used in future data search requests. Similarly, the manual operation includes trigger action by the operator where the VDC triggers the system when they observe a traffic violation that further initiated the PDD to capture a 7-seconds video recording from loop-recording taking 4 seconds pre-trigger and 3 seconds post-trigger moment. In addition, each file sent to the Falcon Command & Control center (FCCc) consists of at least 3 images, 3 seconds audio recording (post trigger), date & time, GPS/location coordinates, speed reports, LPR. Similarly, if VDC triggers again during the first 7 seconds before timer ends then the video length will be extended to an extra 5 seconds to a total video length of 12 seconds instead of 7 seconds and a total audio of 8 seconds instead of 3 seconds.

In another embodiment of the present invention, the FCCc has the power to control all the VDC fleet & discreetly perform many operations on behalf of them. Specifically, the functions of the FCCc includes but not limited to, live tracking all the VDC's with extreme accuracy. Further the FCCc has an ability to change any settings of specific or all PDD's. For example, the FCCc has an ability to change recording quality to 4K in certain areas of the city and reduce it to 2K or 1080P for other cities depending on the demand. Settings can be changed to individual PDD's or by geolocation or time. Additionally, the FCCc has an ability to update the firmware on PDD's remotely, view live feed of the installed PDD's and check the view of specific PDD camera in real time, record certain lengths and footage out of any desired PDD, perform searches for certain license plate or vehicle type or colour without the knowledge of the operators.

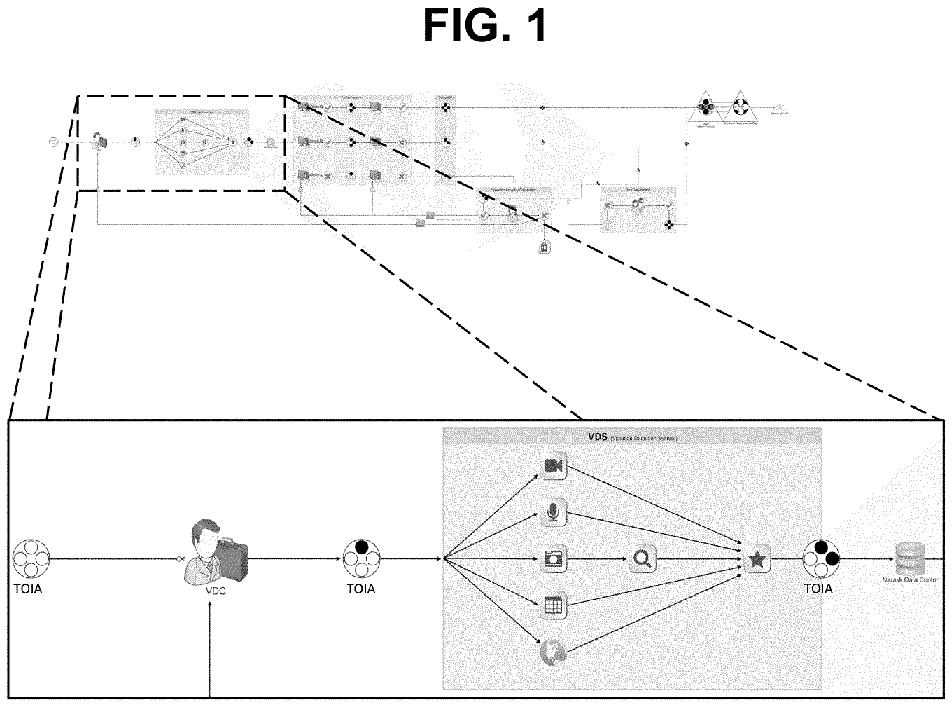

In a further embodiment of the present invention, the disclosed intelligent traffic violation detection system operates by installing the PDD into any vehicle that can be non-distractably operated by a VDC. Now, referring to FIG. 1, the VDC is the person who operates the PDD when the VDC notices a traffic violation. Once the VDC identifies a traffic violation, the VDC enables the remote trigger button located on the steering wheel of the vehicle. Once the trigger button is enabled, the PDD captures the traffic violation data in the form of a video recording, an audio recording, images, time and location etc. and transfers the data to the data centres. The data centres further classify the data accordingly and send the data either to FCCc or the Eye Department via TOIA for further verification. The trigger action that have been detailed above enables real time capturing and recoding of the traffic violation can be further configured as automatic or manual. Initially, the TOIA is stored in the PDD and is enabled when at least two P-Tokens are assigned, in which one P-Token is assigned by the VDC when they press the remote trigger button while the second P-Token is assigned automatically by the PDD device when it identifies the 10 required clues and operation is filed correctly with no errors. In the next step, the TOIA with the two assigned P-Tokens is further encrypted and transferred to the specified data centres where the traffic violation data stored in the TOIA is decrypted and will be transferred to the Eye dept. for further evaluation.

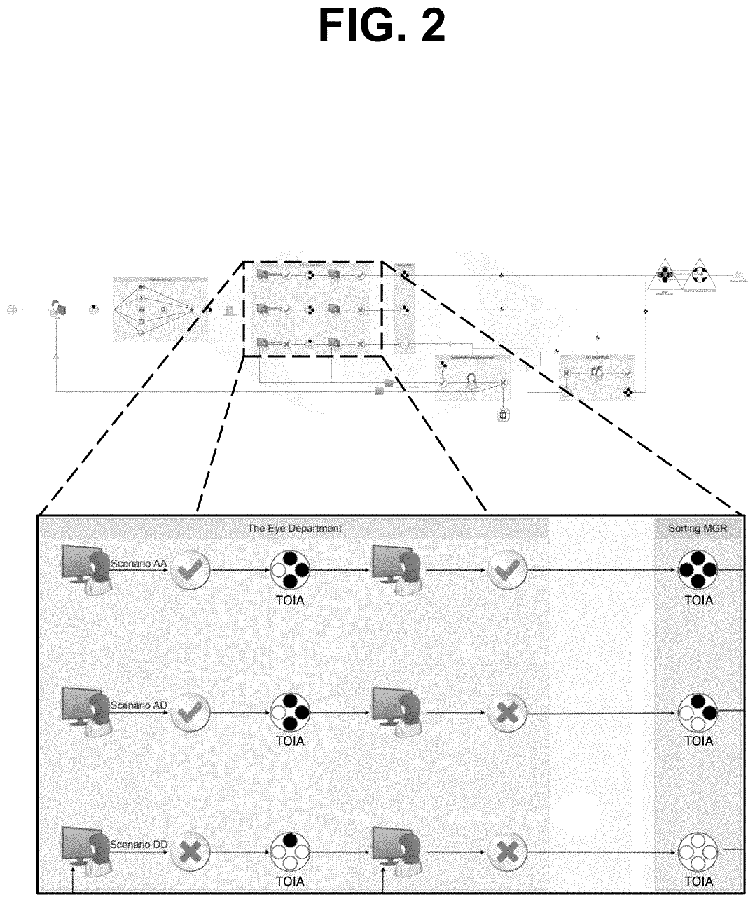

Now referring to FIG. 2 which is the continuation step from FIG. 1, the classified information is again loaded back to TOIA and further transferred to the “Eye department”. The Eye department comprises of two iris employees who reviews the traffic violation data embedded in the TOIA and approves or rejects the traffic violation claims. In this stage, each iris employee independently reviews the traffic violation data and approves or rejects accordingly. This result in three different scenarios. Scenario A is when both iris employees approve the traffic violation data, two additional P-Tokens, will be added to the TOIA leading to a total of four P-Tokens. Whereas Scenario B is when one iris employee approves the received traffic violation data, adding one P-Token to the TOIA where the total P-Token count becomes three. In contrast, if the other iris employee rejects the received traffic violation data, it removes the P-Token added by the other iris employee leading to a total of two P-Token count in the TOIA which means this TOIA will be transferred to JD for further review. Scenario C is when both iris employees reject the received traffic violation data, the two available P-Tokens in the TOIA are removed leading to a total of zero P-Token count in the TOIA which results in sending this specific TOIA to OAD.

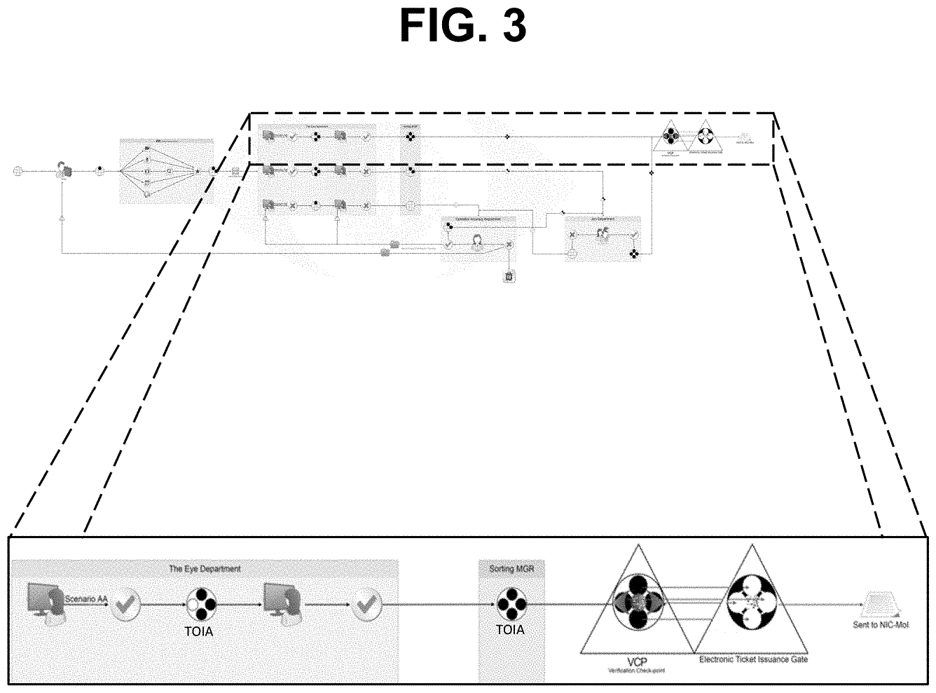

Turning now to FIG. 3, once a TOIA is assigned with four P-Tokens, it is further transferred to VCP where the VCP will ensure that TOIA has all four P-Tokens and grants the TOIA with a GES. Once a TOIA is granted with a GES, it can be safely transferred to ETI-Gate to issue an official electronic ticket that will further be directed to the appropriate government entity.

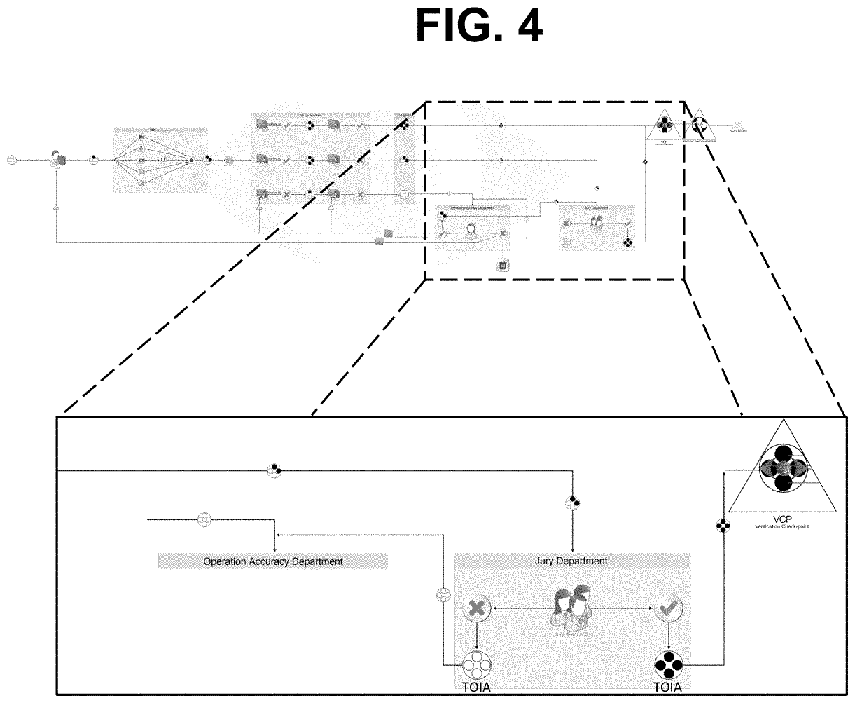

As visualised in FIG. 4, the TOIA with two P-Tokens will be directed to the JTD which comprises of three members who further reviews the TOIA with two P-Tokens and takes a decision to approve or reject the TOIA. In a scenario where the JTD approves the provided traffic violation data, they grant two additional P-Tokens to the specific TOIA leading to a total of four P-Tokens for specific TOIA. Once a TOIA is assigned with four P-Tokens, it can be further directed to VCP where the VCP will ensure that TOIA has all four P-Tokens and grants the TOIA with a GES. Once a TOIA is granted with a GES, it can be safely transferred to ETI-Gate to issue an official electronic ticket that will further be directed to the appropriate government entity. In contrast, if the JTD rejects the provided traffic violation data, the two P-Tokens provided to the TOIA will be removed leading to a zero P-Tokens. TOIA with the zero P-Tokens are further transferred to OAD.

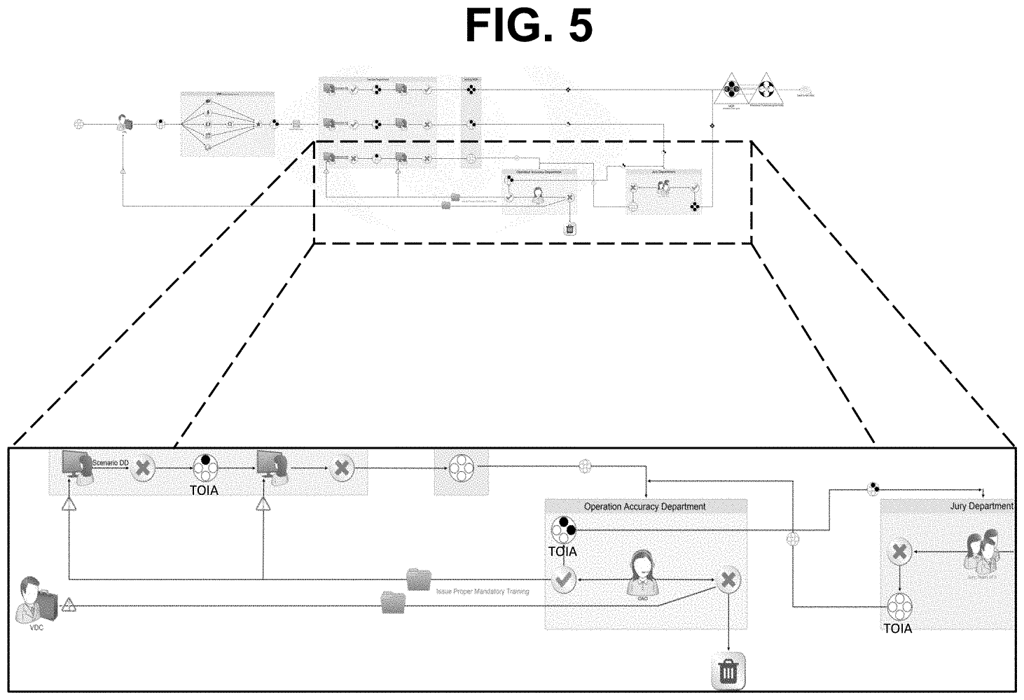

Now turning to FIG. 5, all the TOIA's with zero P-Tokens are directed to OAD which comprises of an OAO who will review the directed traffic violation data and re-evaluate the case and approves or rejects the provided traffic violation data claims. The outcomes of this re-evaluation give rise to different scenarios. In a scenario where the OAO approves the traffic violation data claims, the OAO regrants two 2 P-Tokens to the specific TOIA and redirects the case to JTD for further re-evaluation. Nevertheless, if the OAO rejects the provided traffic violation data claims, the claims will be disposed in the trash. Furthermore, if JTD approves the TOIA sent by OAD, the OAO will receive a detailed report on who denied the claim from the Eye department and will issue a mandatory training to those two employees, so they improve their skills thus improving overall quality. Similarly, if OAO denies the violation claim, a mandatory training shall be issued to the VDC who sent the wrong violation in the first instance and a short investigation might open on rare occasions. Correspondingly, when the JTD has sent TOIA and it was approved, OAO will receive notification upon which one of the two iris employees has evaluated that violation claim wrong. However, of JTD denies the violation claim, OAO will be notified regarding which one of the two iris employees has approved the violation claim.

In a preferred embodiment of the present invention, the intelligent traffic violation detection system comprises of a Portable Detection Device (PDD) installed into a vehicle, wherein the said PDD further comprises a portable case, wherein the portable case further includes a central processing unit (CPU), at least one memory means, a video processing means, an image processing means, a License Plate Recognition (LPR) means, a Global position system means (GPS), a network system means, a display means, at least one audio output means, at least one plug output means, at least one power means, at least one video capturing camera module, at least one image capturing camera module, at least one camera mount, at least one remote trigger, at least one microphone, at least one power source and a mobile application; a Violation Detection Captain (VDC), wherein the said VDC is capable of operating the PDD to capture and report the traffic violations in real-time; a Transfer of Information Agent (TOIA), wherein the said TOIA is used to transfer the violation detection data and further consists of at least four Permission Token (PT) slots and each slot is assigned with at least one PT at different levels of confirmation and verification of violation detection data; a Falcon Command & Control center (FCCc), wherein the said FCCc has the power to control all the VDC fleet and discreetly perform and monitor operations of and on behalf of VDC, particularly the operations of FCCc include live tracking all the VDC's with extreme accuracy, update the settings of any PDD, remotely update the firmware of PDD, view live feed of the installed PDD's and check the view of specific PDD camera in real time, record certain lengths and footage out of any desired PDD, and perform searches for certain license plate, vehicle type and colour without the knowledge of VDC; a Violation Verification System (VVS), wherein the said VVC is capable of investigating the violation data received from PDD to ensure accuracy, maximize security, and minimize errors to avoid issuing wrong claims, wherein the said VVC includes an Eye department, a Jury Team Department (JTD) and Operation Accuracy department (OAD) wherein, the Eye department consists of at least two iris employees who reviews the traffic violation data embedded in the TOIA and approves or rejects the traffic violation claims, the JTD consists of team of three Jury members that analyzes TOIA and take decisions either to approve the claim and grant TOIA with 2 P-Tokens or deny the claim and remove 2 P-Tokens, the OAD consists of an Operation Accuracy Officer (OAO) who re-evaluates the traffic violation data embedded in the TOIA and take decisions either to approve the violation claim and grant TOIA with two P-Tokens and TOIA is redirected to JTD for re-evaluation or deny the claim and dispose the TOIA; and a Verification Check Point (VCP), wherein the VCP will ensure that TOIA has all four P-Tokens and grants the TOIA with a Golden Eye Stamp (GES) and once TOIA is granted with GES it is safely sent to Electronic Ticket Issuance Gate (ETI-Gate) to issue an official Electronic ticket that will then be sent to the appropriate government entity.

In the same embodiment of the present invention, the said network system means includes virtual personal network as well as wireless network systems such as Bluetooth, Wi-Fi and mobile networks such as 5G.

In the same embodiment of the present invention, the said violation detection data transferred to the TOIA includes video recordings, audio recordings, images, LPR information, Date of violation, time of violation, location of violation, speedometer reading, VDC identity information and PDD identity information and the said TOIA is built using blockchain based encryption systems so that the violation detection data transferred by the TOIA is highly secure and safe from manipulation.

In the same embodiment of the present invention, the PDD of the intelligent traffic violation detection system is easily installable to any type of vehicle. In addition, the system allows user (VDC) to operate the PDD without any distractions from driving as the remote trigger buttons are suitably installed on the steering wheel of the vehicle. The remote trigger button is arranged on the steering wheel at a similar location where handsfree or Bluetooth or volume buttons are generally installed, and the remote trigger is operated only using the thumb finger to minimize distractions.

In the same embodiment of the present invention, the said video and image camera modules of PDD are mounted at front and rear positions of the vehicle in a manner that the said camera modules are not directly visible to the other drivers but are capable of capturing at least 360-degree view around the vehicle.

In the same embodiment of the present invention, the said image capturing camera module of PDD is configured in a way that the said image capturing camera module is capable of capturing high resolution images to identify the vehicle license plate characters at a distance of at least 50 Meter.

In the same embodiment of the present invention, the said image capturing camera module of PDD is configured in a way that the said image camera module is capable of capturing high resolution images of license plates, physical and visual features of vehicles passing by and attach a geo location to the specific vehicle data so that the same data can be utilised for the purposes of tracing any specific vehicle that is associated with illegal activities.

In the same embodiment of the present invention, the said video capturing camera module of PDD is configured in a way that the said video capturing camera module is capable of capturing videos in different video qualities which includes 4K, 2K and 1080 pixels.

In the same embodiment of the present invention, the said microphone of PDD is configured in a way that the said microphone enables VDC to communicate with managers when requested by FCCc as well as to spell out certain commands that associate with each violation file with the video and images as well as pronounce the violation type as video is recorded.

In the same embodiment of the present invention, the said PPD of the intelligent traffic violation detection system is equipped with an artificial intelligence program with integrated traffic violation and theft data so that it is capable to intelligently recognise the suspicious vehicles and their driving data and alert the VDC and the FCCc to take further action. Additionally, the said artificial intelligence program utilises machine learning and learns commands and instructions from the data received from the VDC and the FCCc and the corresponding conversations and exchange of traffic violation data so that the said artificial intelligence program is efficiently trained in a way to take error free autonomous decisions on traffic violations.

In the same embodiment of the present invention, the said PPD's hardware is configured in a way that it is capable of quickly, efficiently and robustly handle and process the high volume of traffic violation data.

In the same embodiment of the present invention, the said audio output means of the said PPD allow FCCc to communicate with the VDC in real time to provide certain instructions to the VDC.

In the same embodiment of the present invention, the mobile application is configured to monitor and operate the PDD.

In another preferred embodiment of the present invention, a process of intelligent traffic violation detection system is disclosed. The process comprising steps of: (a) installing at least one PDD in a vehicle; (b) operating the PDD automatically with the help of Artificial Intelligence, wherein the automatic operation includes no trigger action and is configured to loop-record five minutes, takes at least one image every three seconds, CPU will process the Licence Plate Recognition data (LPR) and automatically sends .txt files of all plate numbers, date, time and location to the data centres for data collection that can be used in future data search requests; (c) operating the PDD manually with the help of VDC, wherein the manual operation includes trigger action by the operator where the VDC triggers the system when they observe a traffic violation that further initiated the PDD to capture a 7-seconds video recording from loop-recording taking 4 seconds pre-trigger and 3 seconds post-trigger moment extendable to 7 seconds if remote trigger is pressed again; (d) allocating first P-Token to the TOIA by the VDC when the VDC triggers the remote trigger button while the second P-Token is assigned automatically by the PDD device when it identifies the 10 required clues and operation is filed correctly with no errors; (e) transferring the violation detection data via TOIA to the data centres where the data is classified and further transferred to FCCc or the Eye Department for further verification; (f) verifying the traffic violation data, in which each iris employee independently reviews the traffic violation data and approves or rejects accordingly and this results in at least three scenarios where in the first scenario, when both iris employees approve the traffic violation data, two additional P-Tokens will be added to the TOIA leading to a total of four P-Tokens whereas in the second scenario, when one iris employee approves the received traffic violation data, adding one P-Token to the TOIA where the total P-Token count becomes three and in contrast, if the other iris employee rejects the received traffic violation data, it removes the P-Token added by the other iris employee leading to a total of two P-Token count in the TOIA which means this TOIA will be transferred to JTD for further review, and in the third scenario, when both iris employees reject the received traffic violation data, the two available P-Tokens in the TOIA are removed leading to a total of zero P-Token count in the TOIA which results in sending this specific TOIA to OAD; (g) transferring the verified TOIA that is assigned with four P-Tokens to VCP where the VCP will ensure that TOIA has all four P-Tokens; and (h) granting TOIA with a GES and transferring to ETI-Gate to issue an official electronic ticket that will further be directed to the appropriate government entity.

In the same embodiment of the present invention, all the TOIA's with zero P-Tokens are directed to OAD which comprises of an OAO who reviews the directed traffic violation data and re-evaluate the case and approves or rejects the provided traffic violation data claims and the outcomes of this re-evaluation would give rise to different scenarios where if the OAO approves the traffic violation data claims, the OAO regrants two 2 P-Tokens to the specific TOIA and redirects the case to JTD for further re-evaluation and if the OAO rejects the provided traffic violation data claims, the claims will be disposed and if JTD approves the TOIA sent by OAD, the OAO will receive a detailed report on who denied the claim from the Eye department and will issue a mandatory training to those two employees, so they improve their skills thus improving overall quality and if OAO denies the violation claim, a mandatory training shall be issued to the VDC who sent the wrong violation in the first instance and a short investigation might open on rare occasions and when the JTD has sent TOIA and it was approved, OAO will receive notification upon which one of the two iris employees has evaluated that violation claim wrong and if JTD denies the violation claim, OAO will be notified regarding which one of the two iris employees has approved the violation claim thus creating a system with almost zero errors. Additionally, all the steps associated with the intelligent traffic violation detection system are autonomously processed without human oversight once the artificial intelligence program is efficiently trained to take error free autonomous decisions.

### ABBREVIATIONS

Electronic Ticket Issuance Gate (ETI-Gate)
Falcon Command & Control center (FCCc)
Golden Eye Stamp (GES)
Jury Team Department (JTD)
Operation Accuracy Department (OAD)
Operation Accuracy Officer (OAO)
Permission tokens (P-Tokens)
Portable Detection Device (PDD)
Transfer of Information Agent (TOIA)
Verification Check Point (VCP)
Violation Detection Captain (VDC)
Violation Verification System (VVS)

Having fully and clearly described the invention so as to enable one having skill in the art to understand and practice the same, the invention claimed is:

1. An intelligent traffic violation detection system, the system comprising:
a) a Portable Detection Device (PDD) installed into a vehicle, wherein the said PDD further comprises a portable case, wherein the portable case further includes a central processing unit (CPU), at least one memory means, a video processing means, an image processing means, a License Plate Recognition (LPR) means, a Global position system means (GPS), a network system means, a display means, at least one audio output means, at least one plug output means, at least one power means, at least one video capturing camera module, at least one image capturing camera module, at least one camera mount, at least one remote trigger, at least one microphone, at least one power source and a mobile application;
b) a Violation Detection Captain (VDC), wherein the said VDC is capable of operating the PDD to capture and report the traffic violations in real-time;
c) a Transfer of Information Agent (TOIA), wherein the said TOIA is used to transfer the violation detection data and further consists of at least four Permission Token (PT) slots and each slot is assigned with at least one PT at different levels of confirmation and verification of violation detection data;
d) a Falcon Command & Control center (FCCc), wherein the said FCCc has the power to control all the VDC fleet and discreetly perform and monitor operations of and on behalf of VDC, particularly the operations of FCCc include live tracking all the VDC's with extreme accuracy, update the settings of any PDD, remotely update the firmware of PDD, view live feed of the installed PDD's and check the view of specific PDD camera in real time, record certain lengths and footage out of any desired PDD, and perform searches for certain license plate, vehicle type and colour without risking the safety of the VDC;
e) a Violation Verification System (VVS), wherein the said VVC is capable of investigating the violation data received from PDD to ensure accuracy, maximize security, and minimize errors to avoid issuing wrong claims, wherein the said VVC includes an Eye department, a Jury Team Department (JTD) and Operation Accuracy department (OAD) wherein, the Eye department consists of at least two iris employees who reviews the traffic violation data embedded in the TOIA and approves or rejects the traffic violation claims, the JTD consists of team of three Jury members that analyzes TOIA and take decisions either to approve the claim and grant TOIA with 2 P-Tokens or deny the claim and remove 2 P-Tokens, the OAD consists of an Operation Accuracy Officer (OAO) who re-evaluates the traffic violation data embedded in the TOIA and take decisions either to approve the violation claim and grant TOIA with two P-Tokens and TOIA is redirected to JTD for re-evaluation or deny the claim and dispose the TOIA; and
f) a Verification Check Point (VCP), wherein the VCP will ensure that TOIA has all four P-Tokens and grants the TOIA with a Golden Eye Stamp (GES) and once TOIA is granted with GES it is safely sent to Electronic Ticket Issuance Gate (ETI-Gate) to issue an official Electronic ticket that will then be sent to the appropriate government entity.

2. The system of claim 1, wherein the said network system means includes virtual personal network as well as wireless network systems such as Bluetooth, Wi-Fi and mobile networks such as 5G.

3. The system of claim 1, wherein the said violation detection data transferred to the TOIA includes video recordings, audio recordings, images, LPR information, Date of violation, time of violation, location of violation, speedometer reading, VDC identity information and PDD identity information.

4. The system of claim 1, wherein the said TOIA is built using blockchain based encryption systems so that the violation detection data transferred by the TOIA is highly secure and safe from manipulation.

5. The system of claim 1, wherein the said PDD of the intelligent traffic violation detection system is easily installable to any type of vehicle and the PDD enables VDC to undistractedly operate the PDD without any distractions from driving as the remote trigger buttons are suitably installed on the steering wheel of the vehicle and the remote trigger button is arranged on the steering wheel at a similar location where handsfree or Bluetooth or volume buttons are generally installed and the remote trigger is operated only using the thumb finger to minimize distractions.

6. The system of claim 1, wherein the said video and image camera modules of PDD are mounted at front and rear positions of the vehicle in a manner that the said camera modules are not directly visible to the other drivers but are capable of capturing at least 360-degree view around the vehicle.

7. The system of claim 1, wherein the said image capturing camera module of PDD is configured in a way that the said image capturing camera module is capable of capturing high resolution images to identify the vehicle license plate characters at a distance of at least 50 Meter.

8. The system of claim 1, wherein the said image capturing camera module of PDD is configured in a way that the said image camera module is capable of capturing high resolution images of license plates, physical and visual features of vehicles passing by and attach a geo location to the specific vehicle data so that the same data can be utilised for the purposes of tracing any specific vehicle that is associated with illegal activities.

9. The system of claim 1, wherein the said video capturing camera module of PDD is configured in a way that the said video capturing camera module is capable of capturing videos in different video qualities which includes 4K, 2K and 1080 pixels.

10. The system of claim 1, wherein the said microphone of PDD is configured in a way that the said microphone enables VDC to communicate with managers when requested by FCCc as well as to spell out certain commands that associate with each violation file with the video and images as well as pronounce the violation type as video is recorded.

11. The system of claim 1, wherein the said PPD of the intelligent traffic violation detection system is equipped with an artificial intelligence program with integrated traffic violation and theft data so that it is capable to intelligently recognise the suspicious vehicles and their driving data and alert the VDC and the FCCc to take further action.

12. The artificial intelligence program of claim 11, wherein the said artificial intelligence program utilises machine learning and learns commands and instructions from the data received from the VDC and the FCCc and the corresponding conversations and exchange of traffic violation data so that the said artificial intelligence program is efficiently trained in a way to take error free autonomous decisions on traffic violations.

13. The system of claim 1, wherein the said PPD's hardware is configured in a way that it is capable of quickly, efficiently and robustly handle and process the high volume of traffic violation data.

14. The system of claim 1, wherein the said audio output means of the said PPD allow FCCc to communicate with the VDC in real time to provide certain instructions to the VDC.

15. The system of claim 1, wherein the mobile application is configured to monitor and operate the PDD.

16. A process of intelligent traffic violation detection system, the process comprising steps of:
a) installing at least one PDD in a vehicle;
b) operating the PDD automatically with the help of Artificial Intelligence, wherein the automatic operation includes no trigger action and is configured to loop-record five minutes, takes at least one image every three seconds, CPU will process the Licence Plate Recognition data (LPR) and automatically sends text files of all plate numbers, date, time and location to the data centres for data collection that can be used in future data search requests;
c) operating the PDD manually with the help of VDC, wherein the manual operation includes trigger action by the operator where the VDC triggers the system when they observe a traffic violation that further initiated the PDD to capture a 7-seconds video recording from loop-recording taking 4 seconds pre-trigger and 3 seconds post-trigger moment extendable to 7 seconds if remote trigger is pressed again;
d) allocating first P-Token to the TOIA by the VDC when the VDC triggers the remote trigger button while the second P-Token is assigned automatically by the PDD device when it identifies the 10 required clues and operation is filed correctly with no errors;
e) transferring the violation detection data via TOIA to the data centres where the data is classified and further transferred to FCCc or the Eye Department for further verification;
f) verifying the traffic violation data, in which each iris employee independently reviews the traffic violation data and approves or rejects accordingly and this results in at least three scenarios where in the first scenario, when both iris employees approve the traffic violation data, two additional P-Tokens will be added to the TOIA leading to a total of four P-Tokens whereas in the second scenario, when one iris employee approves the received traffic violation data, adding one P-Token to the TOIA where the total P-Token count becomes three and in contrast, if the other iris employee rejects the received traffic violation data, it removes the P-Token added by the other iris employee leading to a total of two P-Token count in the TOIA which means this TOIA will be transferred to JTD for further review, and in the third scenario, when both iris employees reject the received traffic violation data, the two available P-Tokens in the TOIA are removed leading to a total of zero P-Token count in the TOIA which results in sending this specific TOIA to OAD;
g) transferring the verified TOIA that is assigned with four P-Tokens to VCP where the VCP will ensure that TOIA has all four P-Tokens; and
h) granting TOIA with a GES and transferring to ETI-Gate to issue an official electronic ticket that will further be directed to the appropriate government entity.

17. The process of claim 16, wherein all the TOIA's with zero P-Tokens are directed to OAD which comprises of an OAO who reviews the directed traffic violation data and re-evaluate the case and approves or rejects the provided traffic violation data claims and the outcomes of this re-evaluation would give rise to different scenarios where if the OAO approves the traffic violation data claims, the OAO regrants two 2 P-Tokens to the specific TOIA and redirects the case to JTD for further re-evaluation and if the OAO rejects the provided traffic violation data claims, the claims will be disposed and if JTD approves the TOIA sent by OAD, the OAO will receive a detailed report on who denied the claim from the Eye department and will issue a mandatory training to those two employees, so they improve their skills thus improving overall quality and if OAO denies the violation claim, a mandatory training shall be issued to the VDC who sent the wrong violation in the first instance and a short investigation might open on rare occasions and when the JTD has sent TOIA and it was approved, OAO will receive notification upon which one of the two iris employees has evaluated that violation claim wrong and if JTD denies the violation claim, OAO will be notified regarding which one of the two iris employees has approved the violation claim thus creating a system with almost zero errors.

18. The process of claim 16, wherein all the said steps associated with the intelligent traffic violation detection system are autonomously processed without human oversight once the artificial intelligence program is efficiently trained to take error free autonomous decisions.
